(19) United States
(12) Patent Application Publication
(10) Pub. No.: US 2013/0070575 A1
(43) Pub. Date: Mar. 21, 2013

(54) ALARM METHOD AND APPARATUS IN PORTABLE TERMINAL

(71) Applicants: Hyun-Soo KIM, Seoul (KR); Jin Park, Yongin-si (KR); Kwang-Lae Kwak, Seoul (KR)

(72) Inventors: Hyun-Soo KIM, Seoul (KR); Jin Park, Yongin-si (KR); Kwang-Lae Kwak, Seoul (KR)

(73) Assignee: Samsung Electronics Co., Ltd., Suwon-si (KR)

(21) Appl. No.: 13/617,474

(22) Filed: Sep. 14, 2012

(30) Foreign Application Priority Data
Sep. 16, 2011 (KR) 10-2011-0093511

(51) Int. Cl. G04G 13/02

(52) U.S. Cl. 368/250

(57) ABSTRACT

An alarm method in a portable terminal is provided, including setting an alarm by setting an alarm time, setting output information to be output at the alarm time, and setting an output device for receiving and displaying the output information; outputting a preset alarm sound when the set alarm time arrives, and obtaining the output information to be output at the alarm time; and transmitting the obtained output information to the set output device.

### PRIORITY

This application claims priority under 35 U.S.C. §119(a) to a Korean Patent Application filed in the Korean Intellectual Property Office on Sep. 16, 2011, and assigned Serial No. 10-2011-0093511, the contents of which are incorporated herein by reference.

### BACKGROUND OF THE INVENTION

1. Field of the Invention

The present invention generally relates to a portable terminal, and more particularly to an alarm method in a portable terminal.

2. Description of the Related Art

As portable terminals have evolved to smart phones, various general functions and uses of the portable terminal have been developed.

Portable terminals include a fundamental feature of an alarm function to inform a user of the arrival of a specific time. However, a conventional alarm function simply outputs an alarm sound at a set alarm time.

There is also an N-screen service among functions recently used in the portable terminal. The N-screen service allows wireless communication devices to use multimedia contents together through interaction between the wireless communication devices. For example, the N-screen service provides a screen sharing function by which multimedia contents currently reproduced in a portable terminal can be also reproduced in a television, a desktop personal computer, or a tablet personal computer.

A need exists for various useful aspects obtained by providing new type of smart alarm function utilizing the screen sharing function of the N-screen service to the conventional simple alarm function of the portable terminal.

### SUMMARY OF THE INVENTION

Accordingly, the present invention has been made to solve the above-stated problems occurring in conventional systems, and the present invention provides a more convenient and useful alarm function by improving a conventional simple alarm function.

In accordance with an aspect of the present invention, there is provided an alarm method in a portable terminal, including setting an alarm by setting an alarm time, setting output information to be output at the alarm time, and setting an output device for receiving and displaying the output information; outputting a preset alarm sound when the set alarm time arrives, and obtaining the output information to be output at the alarm time; and transmitting the obtained output information to the set output device.

In accordance with another aspect of the present invention, there is provided an alarm apparatus in a portable terminal, including a near field communication module; a wireless transceiver; a key input unit; a display unit; and a controller for controlling an alarm time and controlling output information to be output at the alarm time; and an output device for receiving and displaying the output information set through the key input unit or the display unit. The output information, which will be output at the alarm time together with a preset alarm sound when the set alarm time arrives, is obtained through the near field communication module or the wireless transceiver, and the obtained output information is transmitted to the set output device through the near field communication module or the wireless transceiver.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a portable terminal according to an embodiment of the present invention;

FIG. 2 is a flowchart illustrating a process of setting an alarm according to an embodiment of the present invention;

FIG. 3 is a flowchart illustrating a process of performing an alarm according to an embodiment of the present invention;

FIGS. 4A-4D illustrate a first example of a process of setting an alarm according to an embodiment of the present invention; and

FIGS. 5A-5B illustrate a second example of a process of setting an alarm according to an embodiment of the present invention.

### DETAILED DESCRIPTION OF EMBODIMENTS OF THE PRESENT INVENTION

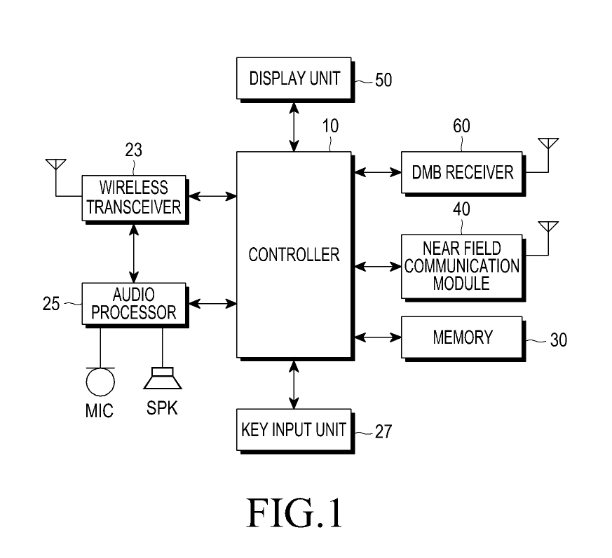

FIG. 1 is a block diagram illustrating a portable terminal according to an embodiment of the present invention.

Referring to FIG. 1, the portable terminal according to the embodiment of the present invention is an easily portable electronic device, including a video telephone, a mobile phone, a smart phone, an International Mobile Telecommunication 2000 (IMT-2000) terminal, a WCDMA terminal, a Universal Mobile Telecommunication Service (UMTS) terminal, a Personal Digital Assistant (PMP) terminal, and a Digital Multimedia Broadcasting (DMB) terminal.

A wireless transceiver 23 includes an RF unit and a modem. The RF unit includes an RF transmitter for up-converting and amplifying a frequency of a transmitted signal, and an RF receiver for low-noise amplifying a received signal and down-converting a frequency of a received signal. The modem includes a transmitter for encoding and modulating a signal to be transmitted and a receiver for demodulating and decoding a signal received from the RF unit.

The wireless transceiver 23 according to the embodiment of the present invention may be used for obtaining output information set to be output at an alarm time separately or together with a near field communication module 40.

An audio process 25 includes a codec, and the codec includes a data codec and an audio codec. The data codec processes packet data, etc., and the audio codec processes voice and audio signals of a multimedia file, etc. The audio processor 25 converts a digital audio signal received from the modem to an analog signal through the audio codec to reproduce the converted analog signal, or converts an analog audio signal generated from a microphone to a digital audio signal through the audio codec to transmit the converted digital audio signal to the modem. The codec may be separately included or included in a controller 10.

The audio processor 25 according to the embodiment of the present invention outputs a preset alarm sound when indentifying a current time that corresponds to a set alarm time, and in this event, the controller 10 controls such that set output information that is obtained.

Further, when a Text To Speech (TTS) function is activated to output information at the alarm time, when the audio processor 25 according to the embodiment of the present invention obtains the output information, the audio processor 25 may output the obtained output information as sound information through an internal speaker (SPK) or an external speaker (not shown), such as an earphone.

A key input unit 27 provides keys for inputting numbers and character information and function keys for setting various functions, as well as a touch pad and the like. When a display unit 50 is implemented in a touch screen scheme, such as a capacitive type or a resistive type, the key input unit 27 may include the preset small number of keys, and the display unit 50 may replace a part of key input functions of the key input unit 27.

A memory 30 provides a program memory and a data memory. The program memory stores a program for controlling a general operation of the portable terminal. The memory 30 may further include an external memory, such as a Compact Flash (CF) memory, a Secure Digital (SD) memory, a Micro-SD memory, a Mini-SD memory, an Extreme Digital (xD) memory, and a memory stick. Further, the memory 30 may include a disk, such as a Hard Disk Drive (HDD) and a Solid State Disk (SSD).

A near field communication module 40 provides a near field wireless communication function, with the near field communication module 40 of an exemplary embodiment of the present invention being a Wi-Fi module that provides a near field wireless communication function according to the IEEE 802.11 standard.

The near field communication module 40 is used for transmission of the obtained output information set to be output at an alarm time to a set output device individually or together with the wireless transceiver 23. For example, the portable terminal may transmit the output information set to be transmitted at an alarm time to a set device, e.g. a television, a computer, and a tablet computer, by using the near field communication module 40.

The display unit 50 may be implemented as a Liquid Crystal Display (LCD) or an Organic Light Emitting Diode (OLED, such as Passive Matrix Organic Light Emitting Diode (PMOLED) and Active Matrix Organic Light Emitting Diode (AMOLED)), and outputs various display information generated in the portable terminal. The display unit 50 includes a touch screen in an electrostatic type or a decompression type, and may be operated as an input unit for controlling the portable terminal together with the key input unit 27.

A user may set an alarm time, set output information to be output at an alarm time, and set an output device for receiving and displaying the output information via the display unit 50 according to the embodiment of the present invention individually or together with the key input unit 27. Further, the user may set a display position at which the output device displays the output information on the display unit 50, either individually or together with the key input unit 27.

A Digital Multimedia Broadcasting (DMB) receiver 60 receives and demodulates a digital broadcast signal received in a digital broadcast center (not shown) to output the demodulated digital broadcast signal to the controller 10.

The controller 10 controls a general operation of the portable terminal according to the embodiment of the present invention, and may switch or control the operation of the portable terminal according to a user's input inputted through the key input unit 27 or the display unit 50. In the meantime, the controller 10 controls an alarm time, controls setting of output information to be output at the alarm time, and controls setting of an output device for receiving and displaying the output information through the key input unit 27 or the display unit 50. The output information to be output at the alarm time is obtained through at least one of the near field communication module 40 or the wireless transceiver 23 when a current time reaches the set alarm time, and the obtained output information is transmitted to the set output device through at least one of the near field communication module 40 or the wireless transceiver 23. The operation of the controller 10 according to the embodiment of the present invention will be described in detail.

Although the block diagram of FIG. 1 does not illustrate devices, such as a Bluetooth module, a camera module, an accelerometer, a proximity sensor, and a geomagnetic sensor, includable in the portable terminal, it is apparent to those skilled in the art that the not-shown devices may be included in the portable terminal according to the embodiment of the present invention to provide corresponding functions.

In the meantime, although not separately described or illustrated, the output device is an electronic device capable of communicating with the portable terminal using the near field communication module 40 or the wireless transceiver 23 and includes devices for supporting at least one of the N-screen service function or a Digital Living Network Alliance (DLNA) function.

Further, the output device of the present invention includes a device having a display screen having a size larger than that of the display unit 50 and may simultaneously display output information on the larger screen.

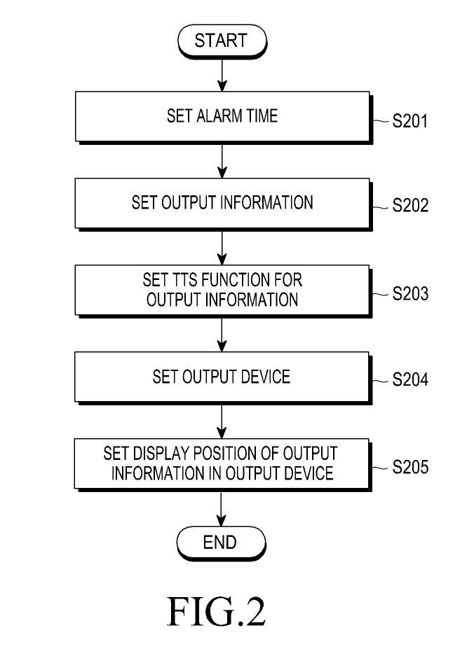

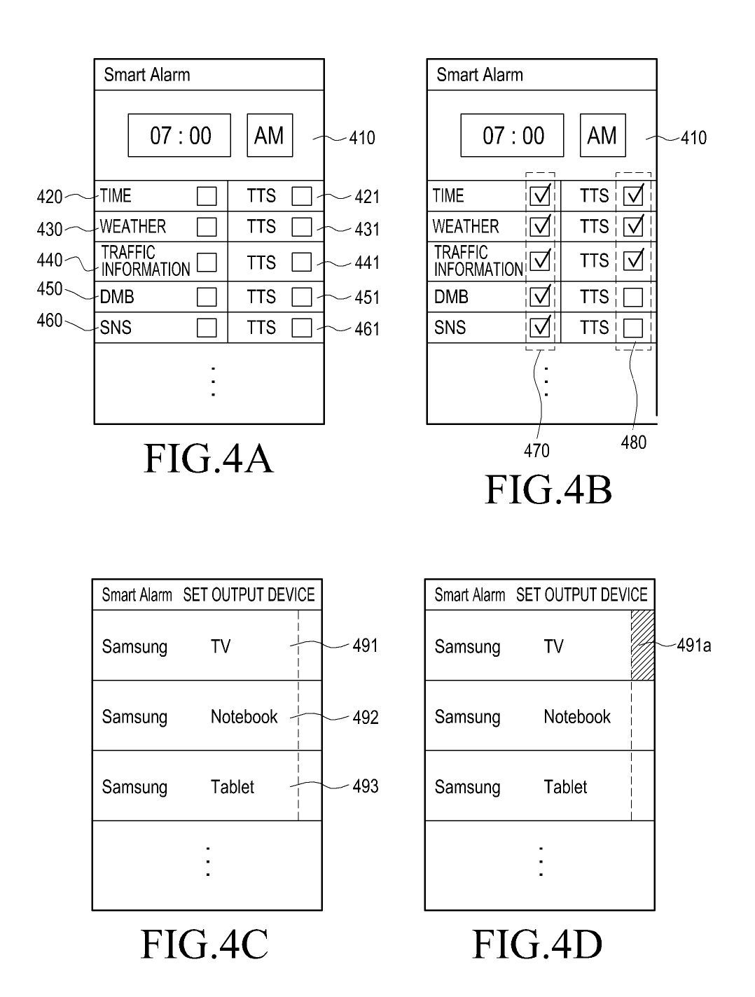

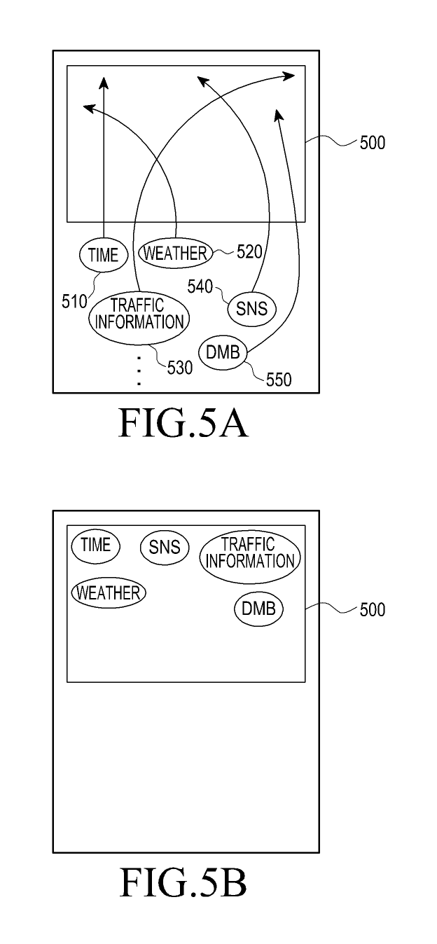

FIG. 2 is a flowchart illustrating a process of setting an alarm according to an embodiment of the present invention. FIGS. 4A-4D illustrate a first example of a process of setting an alarm according to the embodiment of the present invention and FIGS. 5A-5D illustrate a second example of a process of setting an alarm according to the embodiment of the present invention. The process of setting of the alarm according to the embodiment of the present invention will be described with reference to FIGS. 2, 4, and 5.

In steps S201 to S203, the controller 10 receives a setting of an alarm time when an alarm is to be output, a setting of a type of output information to be output together with the set alarm time, and a setting of whether to activate a TTS function depending on the respective output information.

An alarm method according to the embodiment of the present invention additionally provides a preset function together with a general alarm function (e.g. output alarm sound) when the set alarm time arrives, as further described with reference to FIG. 4.

Referring to FIG. 4A, a user may set an alarm time related to an alarm by using key input through the key input unit 27 or a touch screen function of the display unit 50, as denoted by reference number 410, which is the same as a typical and general alarm function.

Differing from the typical and general alarm function, the present invention provides a function through which a user may set output information to be output together with the alarm sound according to a type of output information when the set alarm time arrives. The type of output information corresponds to time, weather, traffic information, DMB, and Social Network Services (SNS), as denoted by reference numbers 420 through 460 in FIG. 4A.

Through setting or selection of the output information according to the embodiment of the present invention, a user may set (i.e. select) any one of the output information 420 through 460 as the information desired to be output together with the alarm sound at the alarm time (e.g. 7 AM).

For example, when the output information 420 through 460 are all set (selected) as the output information to be outputted together with the alarm sound as denoted by reference numbers 470 in FIG. 4B, and the alarm time is set to 7 AM as denoted by reference number 410 in FIG. 4B, when the current time becomes 7 AM, the output information 420 through 460 are also output together with the alarm sound.

For example, when the current time becomes 7 AM, information on the current time, weather of a predetermined region for a predetermined period (e.g. weather of the region in which the portable terminal is located at a corresponding day), and information of traffic conditions of a specific region (e.g. Seoul, where the portable terminal is located) may be displayed, a digital medial broadcast of a preset channel (separately set in a DMB application by a user) by using a DMB receiver may be reproduced, and messages of an account of a user of the SNS (e.g. Twitter or Facebook) may be displayed.

In the meantime, the respective output information 420 through 260 may be output as visual information on a display screen of the display unit 50 or a display device (e.g., a screen of a television) of an output device to be described later, but in the embodiment of the present invention, whether to activate the TTS function for the respective output information 420 through 260 may be individually set such that the respective output information is also output as voice information, as described with reference to FIG. 4B.

When a user activates the TTS function only for the output information 420 through 440 as denoted by reference number 480 of FIG. 4B, when the current time becomes 7 AM, the time 420, the weather 430, and the traffic information 440 may be output (e.g. through the speaker of the portable terminal) as voice information by the TTS function together with the alarm sound.

Although the time 420, the weather 430, the traffic information 440, the DMB 450, and the SNS 460 are illustrated as examples of the information output together with the alarm sound in FIG. 4A, the information output together with the alarm sound is not limited thereto. For example, in addition to reference numbers 420 through 460, when a specific music file or video file is set to output information, the set music file or video file may play while the alarm sound is output at the alarm time.

In steps S204 and S205, the controller 10 receives a setting of an output device to output the output information set in the previous step and sets a display position at which the output information is to be displayed in the output device.

When the type of output information and whether to activate the TTS function depending on output information are set, the controller 10 displays a list of devices 491, 492, and 493 found in a neighboring region by using the near field communication module 40, etc. as illustrated in FIG. 4C. When a user selects any one output device in the list of the displayed devices, the controller 10 displays a selection result (i.e. selected Samsung TV 491) as denoted by reference number 491a of FIG. 4D.

When the output device is selected, the controller 10 displays a virtual screen 500 of the set output device as illustrated in FIG. 5A, and controls such that the list of set output information may be displayed as denoted with reference numbers 510 through 550. A user may set a position at which the output information is to be displayed on the screen of the output device while viewing the screen illustrated in FIG. 5A.

For example, a user may set the display positions at which the respective elements of output information are to be displayed in the output device by moving the output information 510 through 550 to specific positions of the virtual screen 500 of the output device through a drag-touch input using a touch screen function, as denoted by arrows shown in FIG. 5A.

When a user drags (moves) the output information 510 through 550 to the virtual screen 500 of the output device as illustrated in FIG. 5B, actual display positions of the output information 510 through 550 to be output later in the output device are the same or similar to the display positions in the virtual screen 500 illustrated in FIG. 5B.

That is, when the display positions of the output information 510 through 550 in the output device are set as the display positions in the virtual screen 500 illustrated in FIG. 5B, the output device receiving the output information from the portable terminal later displays the output information of a time at an upper-left portion of the output device, the output information of weather at a lower portion of the output information on the time, the output information of SNS at an upper-center portion of the output device, the output information of traffic conditions at an upper-right portion of the output device, and the output information of DMB at a lower portion of the output device.

In this case, it may be preferable that information on the display positions of the aforementioned respective elements of output information are separately stored and transmitted to the output device by the portable terminal, so that the output device displays the respective elements of output information according to the set display positions.

In the meantime, as illustrated in FIGS. 4B and 4D, the alarm time at which the alarm set by a user is to be output, the type of output information set to be output together with the set alarm time, and data related to whether to activate the TTS function for the set output information are stored as separated information (e.g. alarm setting information), so that the controller 10 may provide the alarm function according to the embodiment of the present invention with reference to the alarm setting information later.

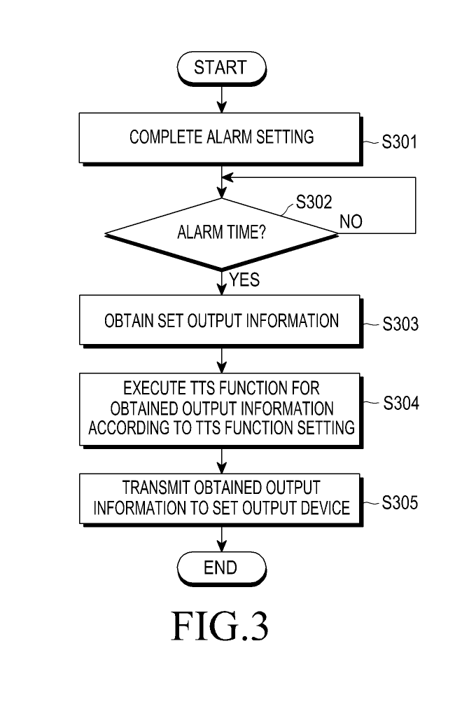

FIG. 3 is a flowchart illustrating a process of performing an alarm method according to an embodiment of the present invention.

In steps S301 and S302, when the alarm setting is completed, the controller 10 identifies the alarm setting information and determined whether the current time corresponds to the alarm time.

When the user completes setting of the alarm time, setting the output information, setting whether to activate the TTS function, and setting the display positions of the output information according to the process of setting of the alarm described with reference to the flowchart of FIG. 2, the controller 10 continuously identifies whether the current time corresponds to the set alarm time. Here, it is preferable that the current time is obtained through a separate time server via wired/wireless communication or through interworking with a base station by using the wireless transceiver.

In steps S303 and S304, the controller 10 controls the obtaining of set output information and executes the TTS function through identification of the TTS setting for the obtained output information.

When the alarm time is identified through the previous step, the controller 10 identifies the alarm setting information while outputting the preset alarm sound and obtains the set output information set such that the output information is output together with the alarm sound. For example, upon a determination that the output information 420 through 460 are all set (selected) as illustrated in FIG. 4B, the controller 10 obtains the output information of the time, the weather, the traffic, the DMB, and the SNS through a predetermined server or execution of an application.

For example, the output information on the time, the weather, and the traffic may be obtained through access to a separate server for providing corresponding information, the output information of the DMB may be obtained by obtaining digital broadcast data through execution of a DMB application, and the output information of the SNS may be obtained by obtaining transmission/reception messages through execution of an application according to a corresponding SNS (e.g. Twitter, Facebook, or Google Plus).

When the output information set to be output at the alarm time is obtained, the controller 10 identifies whether to activate the TTS function for the output information and controls the TTS function for the output information, for which the TTS function is activated, among the obtained output information is executed.

For example, when the TTS function for the output information of the time, the weather, and the traffic are each activated as illustrated in FIG. 4B, and the obtained output information (e.g. text information) of the time, the weather, and the traffic is “September 7, 7 AM”, “It is sunny in Seoul”, and “The traffic is congested so the use of public transportation is recommended”, respectively, the controller 10 may output voice information such as “The current time is September 7, 7 AM, it is expected that Seoul is sunny, and the traffic is congested so the use of public transportation is recommended” through the speaker by means of the TTS function.

In the meantime, since the output information of the DMB for receiving and reproducing the digital broadcast corresponds to visual information, even if the TTS function is activated, it is not easy to apply the TTS function to the output information of the DMB. Accordingly, when the DMB or a separate video reproduction application is set to the output information and the TTS function is activated, the controller 10 controls output of information on an output video through the speaker (e.g. outputs a channel number in a case of the DMB and a name of a currently reproduced video file in a case of a video reproduction application).

In step S304, the controller 10 controls transmission of the obtained output information is to the set output device.

The present invention outputs the output information obtained in step S303 through both the portable terminal and the output device, the obtained output information is output as sound information through the TTS function in the portable terminal and the obtained output information is output as visual information in the output device (i.e. displayed in the display device of the output device).

Accordingly, the controller 10 according to the embodiment of the present invention controls output of the output information, for which the TTS function is activated, among the output information obtained in step S303 through the speaker of the portable terminal, and in step S305 transmits the obtained output information to the output device for the output device to display the output information obtained in step S303.

For example, when the output information 420 through 460 illustrated in FIGS. 4A and 4B are all set to be output and the output device is a television as illustrated in FIGS. 4A and 4D, the controller 10 controls transmission of the obtained output information 420 to 460 to the television.

In this case, the controller 10 simultaneously transmits the set output information to the output device (e.g. the television) and outputs the information on the display positions of the output information to the output device. The output device then outputs the received output information according to the display positions set by the user, as described above with reference to FIGS. 5A-5B.

In this case, considering when the output device is not operated, information such as a booting signal or a driving signal the output information is also output, with the booting signal being preferable to be previously transmitted information, so that the corresponding output device receives and displays the transmitted output information that is provided after the output device turns on.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. An alarm method in a portable terminal, the method comprising:
setting an alarm by setting an alarm time, setting output information to be output at the alarm time, and setting an output device for receiving and displaying the output information;
outputting a preset alarm sound when the set alarm time arrives, and obtaining the output information to be output at the alarm time; and
transmitting the obtained output information to the set output device.

2. The alarm method as claimed in claim 1, further comprising outputting the obtained output information as sound information through a Text To Speech (TTS) function of the portable terminal.

3. The alarm method as claimed in claim 1, wherein setting the alarm comprises:
setting the alarm time;
setting at least one of the output information to be output at the alarm time, and setting the output device for receiving and displaying the output information; and
setting a display position at which the output information is to be displayed on a display unit of the output device.

4. The alarm method as claimed in claim 3, wherein setting the alarm further comprises setting whether to activate a Text To Speech (TTS) function for the set output information.

5. The alarm method as claimed in claim 3, wherein transmitting the obtained output information to the set output device comprises:
transmitting the obtained output information to the set output device; and
transmitting the display position at which the output information is to be displayed on the display unit of the output device to the set output device.

6. The alarm method as claimed in claim 3, wherein transmitting the obtained output information to the set output device comprises:
transmitting information setting the output device;
transmitting the obtained output information to the set output device; and
transmitting the display position at which the output information is to be displayed on a display unit of the output device to the set output device.

7. An alarm apparatus in a portable terminal, the apparatus comprising:
a near field communication module;
a wireless transceiver;
a key input unit;
a display unit; and
a controller for controlling output of information at the alarm time on an output device set through the key input unit or the display unit, with the output information being output at the alarm time together with a preset alarm sound when the set alarm time arrives,
wherein the output information is obtained through the near field communication module or the wireless transceiver, and the obtained output information is transmitted to the set output device through the near field communication module or the wireless transceiver.

8. The alarm apparatus as claimed in claim 7, wherein the controller controls output of the obtained output information as sound information by a Text To Speech (TTS) function through an audio processor.

9. The alarm apparatus as claimed in claim 7, wherein the controller receives a setting of a display position at which the output information is to be displayed in the output device through the key input unit or the display unit.

10. The alarm apparatus as claimed in claim 8, wherein the controller receives a setting regarding whether to activate the TTS function for the set output information through the key input unit or the display unit.

11. The alarm apparatus as claimed in claim 9, wherein the controller controls the display position at which the output information is to be displayed in the output device, with the obtained output information transmitted to the set output device.

12. The alarm apparatus as claimed in claim 9, wherein after transmitting information setting the output device drive through the near field communication module or the wireless transceiver, the display position at which the output information is to be displayed in the output device is transmitted to the set output device while transmitting the obtained output information to the set output device.
